(19) United States
(12) Patent Application Publication
(10) Pub. No.: US 2007/0152975 A1
(43) Pub. Date: Jul. 5, 2007

(54) Touch screen-type input device

(75) Inventors: Takuya Ogihara, Tokyo (JP); Toshiyuki Yanokura, Tokyo (JP); Masayuki Ono, Tokyo (JP)

Correspondence Address: GRIFFIN & SZIPL, PC, SUITE PH-1, 2300 NINTH STREET, SOUTH, ARLINGTON, VA, 22204, US

(73) Assignee: TAKUYA OGIHARA, TOKYO (JP)

(21) Appl. No.: 10/597,880

(22) PCT Filed: Apr. 5, 2005
(86) PCT No.: PCT/JP04/04922

§ 371 Date: Aug. 10, 2006

(30) Foreign Application Priority Data
Feb. 10, 2004 (JP) 2004-032962

(51) Int. Cl. G06F 3/041

(52) U.S. Cl. 345/173

(57) ABSTRACT

A multi-functional remote controller (1) has a multi-functional button (20) consisting of an LCD panel (21), a touch panel (22), a transparent button sheet (23), and mechanical switches (22). The transparent button sheet (23) has a shape with concavities and convexities, and the shape enables a user to recognize the position of each button in the pattern using their sense of touch. When the user presses down the touch panel (22), a mechanical switch (24) is pressed down to give a click sensation.

### TECHNICAL FIELD OF THE INVENTION

The present invention relates to a touch screen-type input device which is used for notebook computers, PDAs, cellular phones and the like.

### BACKGROUND OF THE INVENTION

Recently, touch screens have come into wide use for notebook computers, PDAs, cellular phones, etc. The touch screen has a touch panel on a display such as a liquid crystal panel and enables a user to enter some commands with their finger, a pen, etc. pressing the screen down directly. There are two ways to sense some contact with the touch panel; one is a pressure sensitive type, and the other is an electrostatic type. The former senses variation in pressure, while the latter senses some electronic signals caused by static electricity.

Such a touch screen-type input device has a display on which some numeric buttons, alphabet buttons and various other icon buttons are displayed, and it outputs a signal which indicates that a prescribed icon button was pressed down when the button was pressed down. Here, in order to know which icon button was pressed down, it is necessary to obtain position coordinates pressed down on a touch panel and then search for the icon button which is displayed at the position of those coordinate on the display.

In the use of a conventional touch screen, however, in order to press down a prescribed icon button, a user needs to watch the buttons shown on the display closely when they press down a touch panel. This has caused a problem that a user may press down another not-intended button by mistake if they turn their eyes away from buttons even very briefly while trying to press down an intended button.

Also, another problem has been pointed out; that when a user presses down a touch panel in order to perform input, they cannot obtain such a click sensation as can be obtained when pressing down some conventional input devices such as mechanical buttons and keys, and as a result they cannot confirm that input has been made correctly.

To solve the second problem, some touch screens have been developed which can provide a click sensation for a user who has pressed down a touch panel. As typical examples of such panels, the input devices disclosed in Reference 1 and Reference 2 listed below can be cited. Each of those input devices has a touch panel surrounded by piezoelectric oscillators, and provides a click sensation for a user by driving those piezoelectric oscillators when the touch panel is pressed down.

[Reference 1] JP2001-350592A

[Reference 2] JP 2003-316519A

### SUMMARY OF THE INVENTION

However, the input devices stated in Reference 1 and Reference 2 listed above do not totally solve the first problem that a user may press down a not-intended button by mistake unless they watch the touch panel closely.

Even concerning the second problem, in the use of the input devices stated in Reference 1 and Reference 2 listed above, there are other problems such as high cost and complication of the devices because it is necessary for those devices to be provided with piezoelectric oscillators in order to provide a click sensation.

The present invention was developed to solve those problems. The object of the present invention is to provide a touch screen-type input device which enables a user to input an intended button correctly. Also, another object of the present invention is to provide a touch screen-type input device which produces a click sensation when a button on the display is pressed down, but having a simple construction.

To solve these problems, a touch screen-type input device relating to the present invention comprises; a touch screen consisting of a display panel on which multiple button patterns can be variably displayed for multiple input purposes and a touch panel for sensing contact position information onto the display panel; a transparent button sheet which is disposed on the touch screen and has a shape to enable a user to recognize a position of each button in each button pattern on the display panel by sense of touch; and a control means for determining which button in the button pattern displayed on the display panel was pressed down according to the position information from the touch panel.

Moreover, a touch screen-type input device relating to the present invention comprises; a touch screen consisting of a display panel on which multiple button patterns can be variably displayed for multiple input purposes and a touch panel for sensing contact position information on the display panel; a click sensation providing means for provide a click sensation for a user when a button on the touch screen is pressed down; and a control means for determining which button in the button pattern displayed on the display panel was pressed down according to the position information from the touch panel when the control means receives the position information from the touch panel and a signal indicating that the click sensation providing means was activated.

According to the present invention, it is possible to provide a touch screen-type input device which prevents a user inputting incorrectly because a user can recognized the position of each button by sense of touch. Moreover, it is also possible to provide a touch screen-type input device which can provide a click sensation when a certain buttons is pressed down, and has a simple construction.

### BRIEF DESCRIPTION OF THE DRAWINGS

FIG. 1 is a perspective drawing of the apparent construction of a multi-functional remote controller relating to the embodiment of the present invention.

FIG. 2 is a cross-sectional view of FIG. 1 along the line A-A′.

FIG. 3 is a block diagram schematically illustrating a construction of a controlling circuit of a multi-functional button relating to the embodiment of the present invention.

FIG. 4 is a diagram illustrating a button pattern displayed on an LCD panel of a multi-functional button to the embodiment of the present invention.

FIG. 5 is a diagram illustrating a button pattern displayed on an LCD panel of a multi-functional button relating to the embodiment of the present invention.

FIG. 6 is a diagram illustrating an arrangement of mechanical switches relating to the embodiment of the present invention.

FIG. 7 is a diagram illustrating an arrangement of mechanical switches relating to the embodiment of the present invention.

### DESCRIPTION OF THE PREFERRED EMBODIMENTS

The embodiment of the present invention is described in detail in the following with reference to the drawings. The description of the embodiment includes a description of a multi-functional remote controller as a touch screen-type input device. The multi-functional remote controller functions as a remote controller for home electrical appliances such as televisions, videos, air conditioners, audio devices, and so on.

FIG. 1 is a perspective figure of the apparent construction of a multi-functional remote controller 1 relating to the embodiment of the present invention. As shown in the figure, the multi-functional remote controller 1 consists of a chassis 40 equipped with a display 10, a multi-functional button 20, cursor key 30, and keys A-D 31. The chassis 40 comprises a rotatable hinge part 41 and can be folded in the middle using the hinge part as an axis. Moreover, a printed circuit board mounted with microcomputers, other ICs, etc. as a control means is stored in the chassis 40, but is omitted from the drawing.

The display 10 is for showing various information. The explanation of each button of the multi-functional buttons 20 and information which is input through the multi-functional buttons 20 are shown on the display 10. Besides the multi-functional button 20, the cursor key 30 and the keys A-D 31 are also used as input keys.

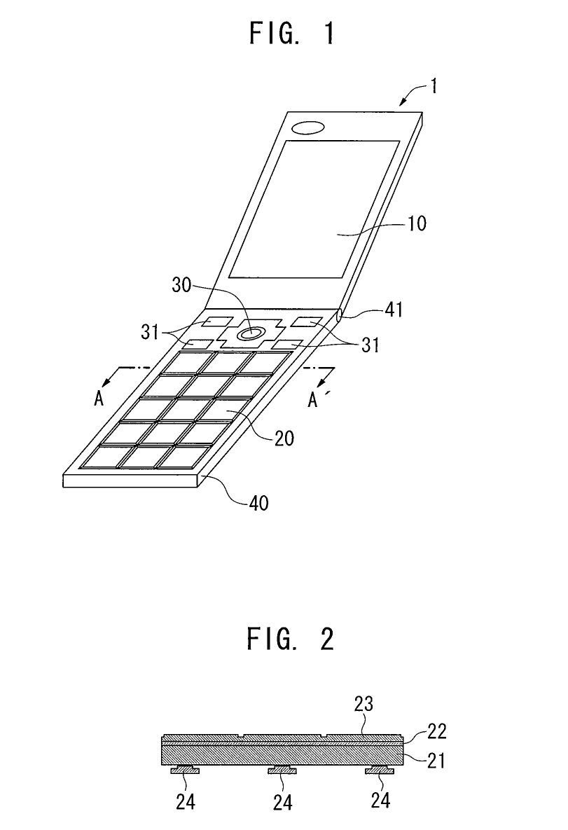

Next, a construction of the multi-functional button 20 is described in detail with reference to the drawings. FIG. 2 is a cross-sectional view of FIG. 1 along the line A-A′. As shown in the figure, the multi-functional button 20 consists of an LCD panel 21, a touch panel 22 on the upper surface of the LCD panel 21, a transparent button sheet 23 covering the touch panel 22, and multiple mechanical switches 24 which are disposed below the LCD panel 21 in order to provide a click sensation.

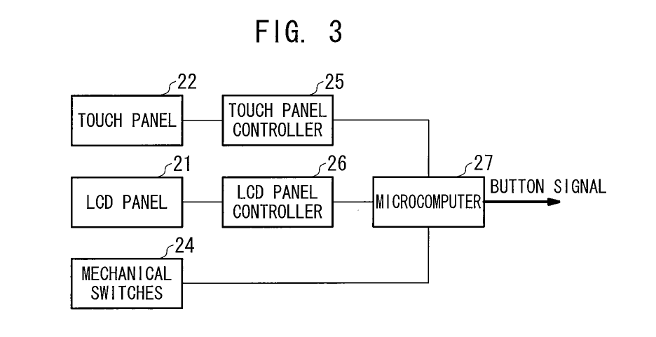

FIG. 3 is a block diagram schematically illustrating a construction of a controlling circuit of the multi-functional button 20. As shown in the figure, the touch panel 22 is connected to a microcomputer 27 via a touch panel controller 25, and the touch panel controller 25 outputs position coordinates on the panel touched by the user to the microcomputer 27 based on the output from the touch panel 22. The LCD panel 21 is connected to the microcomputer 27 via an LCD panel controller 26, and the LCD panel controller 26 displays various button patterns on the LCD panel 21 according to instructions by the microcomputer 27.

Meanwhile, the mechanical switches 24 are connected to the microcomputer 27, and when the mechanical switches 24 are pressed down, they output, to the microcomputer 27, some pressed-down signals which indicate that they were pressed down. This pressed-down signal is output when one of the multiple mechanical switches 24 is pressed down. In this embodiment, the microcomputer 27 functions with the programs stored in memory such as RAM etc.

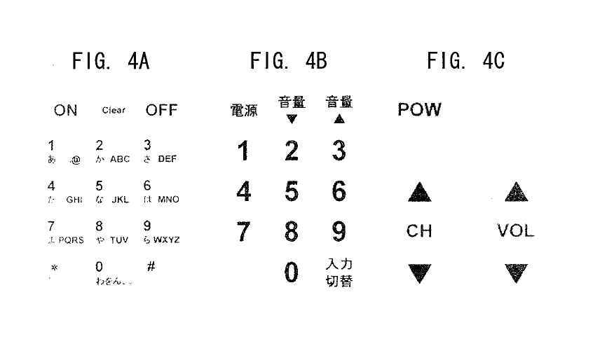

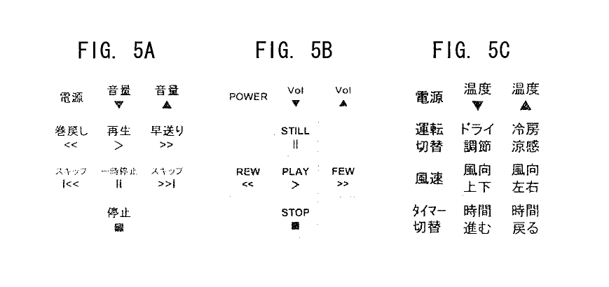

As stated above, the LCD panel 21 displays various button patterns to function as a remote controller for various purposes. FIG. 4 and FIG. 5 are diagrams illustrating the various button patterns displayed on the LCD panel 21 in this embodiment. As shown in the figure, in this embodiment, the buttons are displayed arranged in lines of 3 by 5. Each button has a respective input function.

FIG. 4 (a) shows a screen displayed on the LCD panel 21 in a text-entry mode, which functions as a remote controller for inputting character data. FIG. 4 (b) shows a screen displayed in a television mode functioning as a TV remote controller, and FIG. 4 (c) shows a screen displayed in a simplified television mode functioning as a simplified TV remote controller. FIG. 5 (a) shows a screen displayed in a video mode functioning as a video remote controller, while FIG. 5 (b) shows a screen displayed in an English video mode functioning as an English-version video remote controller, and FIG. 5 (c) shows a screen displayed in an air conditioner mode functioning as an air conditioner remote controller.

The touch panel 22 is for detecting the position of the LCD panel 21 where a user pressed down with their finger, a pen, etc., and it consists of a pressure-sensitive conductive sheet placed between two transparent electrode sheets.

The transparent button sheet 23 is made of transparent material in order to enable a user to view some contents displayed on the LCD panel 21. For example, either acryl or vinyl chloride can be used to make the sheet. Besides, the transparent button sheet 23 has a shape with convexities and concavities. Each of the convexities corresponds to each button displayed on the display panel 21, and each of the concavities corresponds to the boundary between each button. The shape is made with an embossing process. Each button displayed on the LCD panel 21 has a square shape. Because, as stated above, the square buttons displayed on the LCD panel 21 are arranged in lines of 3 by 5, the transparent button sheet 23 also has square buttons arranged in lines of 3 by 5, and an area of each square button of the transparent button sheet 23 is convex, while an area of each boundary between each button is concave. Therefore, if a user moves their finger “from right to left or up and down” on the screen with the finger touching the multi-functional button, they can be made aware that their finger is moving from one button to the next button by sense of touch. This reliably prevents incorrect input such as pressing down an unintended next button by mistake.

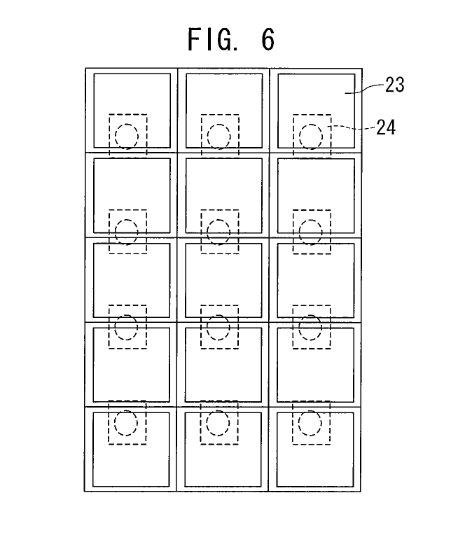

Next, the mechanical switch 24 is described. As shown in the FIG. 2, the multiple mechanical switches 24 are set on the lower surface of the LCD panel 21. FIG. 6 shows the arrangement of the mechanical switches 24 in contradistinction to that of the transparent button sheet 23. The square buttons are arranged in lines of 5 by 3 on the transparent button sheet 23, while 12 mechanical switches 24 are arranged in lines of 3 by 4. Therefore, when a user presses down a prescribed part on the touch panel 22 via the transparent button sheet 23, the LCD panel 21 is pressed down, and then some mechanical switches 24 set below are pressed down. Both the position and number of mechanical switches 24 are varied depending on which part of the LCD panel 21 was pressed down. A user can confirm that they definitely pressed down a button because an actuating force when some mechanical switches 24 are pressed down is provided for a user as a click sensation.

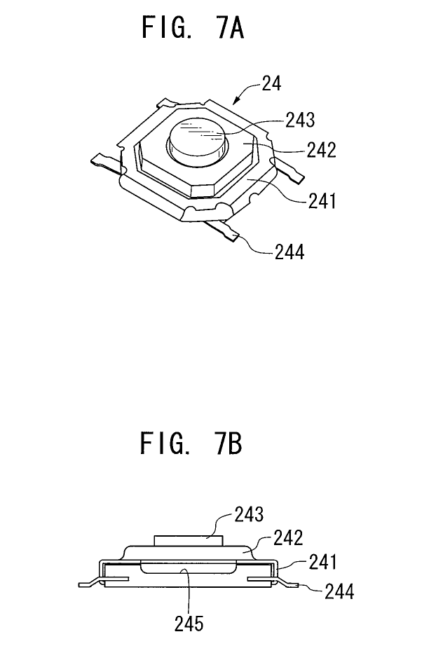

A construction of this mechanical switch 24 is shown in FIG. 7. In this embodiment, a square thin-type general-purpose tact switch is used. FIG. 7 (a) is a perspective drawing of the mechanical switch 24, and FIG. 7 (b) is a cross-sectional view of the mechanical switch 24. As shown in the figure, the mechanical switch 24 consists of a housing 241 as a chassis, a frame 242 supported by the housing 241, a stem 243 disposed on the frame 242, and a terminal 244 as an output terminal. As stated above, when the LCD panel 21 is pressed down, the stem 243 of the mechanical switch 24 under the pressed point is pressed down. When the stem 243 is pressed down, the metallic frame 242 is bent by the actuating force and comes into contact with a metal contact part 245. The frame 242 stops being bent when it comes into contact with the metal contact part 245, and a user is given a click sensation. Besides, due to the metal contact, a pressed-down signal which indicates that the mechanical switch 24 was pressed down is output from the terminal 244 to the microcomputer 27.

It goes without saying that the construction of the mechanical switch 24 is not limited to the construction stated above and that others may be adopted as long as it can function as a device which can give a click sensation to a user. For example, a membrane switch which consists of special PET film where a circuit pattern of conductive paste is screen-printed and some members such as spacers piled up on the film can be used. Moreover, both the position and number of the mechanical switches 24 can be changed accordingly depending on size of the LCD panel 21 etc.

Next, it is described how, in use of the multi-functional remote controller 1 constructed as stated above, a button signal which indicates that one of the buttons displayed on the touch screen was pressed is output.

First, a user presses down an intended button while watching a button pattern displayed on the LCD panel 21. Here, it is assumed that a user presses down a “power” button when the button pattern in a television mode as shown in FIG. 4 (b) is displayed on the LCD panel 21. In this case, because a user presses down the touch panel 22 through the transparent button sheet 23, they are provided with a tactile sensation of buttons due to the shape of the transparent button sheet 23, that is, the shape with concavities and convexities, and this enables them to press down the power button reliably.

Being pressed down by a user, the touch panel 22 sends a prescribed signal to the touch panel controller 25, and the touch panel controller 25 then calculates the position coordinates pressed down by the user. The information of these position coordinates is sent by the touch panel controller 25 to the microcomputer 27. Here, this position coordinate signal means a signal which indicates the position coordinates within an area of the “power” button.

Meanwhile, when the touch panel 22 is pressed down, the LCD panel 21 is also pressed down integrally, and then the mechanical switch 24 is pressed down. Because a user is provided with a click sensation by pressing down the mechanical switch 24, they can confirm that they have pressed down the button reliably. The mechanical switch 24 pressed down outputs a pressed-down signal to the microcomputer 27.

The microcomputer 27 judges, based on the position coordinate signal from the touch panel controller 25, which of the buttons in the button pattern displayed on the LCD panel 21 was pressed down. Here, because the position coordinate signal within the area of the “power” button is sent by the touch panel controller 25, the microcomputer 27 decides that the “power” button was pressed down. Then, the microcomputer 27 outputs a button signal which indicates that the “power” button was pressed down when the microcomputer 27 receives the pressed-down signal send by the mechanical switch 24 within a prescribed period (for example, within 0.5 second or 1 second) after having received the position coordinate signal stated above. As stated above, because the microcomputer 27 is constructed to output a button signal only when it receives a pressed-down signal from the mechanical switch 24, it prevents the button signal being output unless a user is provided with a click sensation. Namely, the button signal is output only when a user recognizes that they have pressed down the button due to a click sensation.

Moreover, the button signals are output in a condition that they are available for a device which uses the button signals. For example, in the case that the multi-functional remote controller 1 functions as a remote controller for a television, the microcomputer 27 outputs button signals which are available for televisions applicable to this case.

The button signal is sent from the multi-functional remote controller 1 to a receiving part of the remote controller of the television, and it then turns the television on or off. The receiving part is not shown in the figure. Infrared output elements in the multi-functional remote controller 1, which are also not shown in the figure, work to send this signal. It goes without saying that a communications interface between it and home electrical appliances is not limited to infrared communication and that it may be a wireless interface such as a wireless LAN, a wired interface using cable, etc.

In the above, the embodiment is described in detail. According to the embodiment, by using a multi-functional remote controller having a display where various button patterns for various home electric appliances can be shown, it is possible for a user to know a position of a button using their senses of sight and touch, and it prevents a user inputting incorrectly. Moreover, it is also possible for a user to be provided with a click sensation, and this enables a user to confirm that they have input through the button reliably.

It should be noted that the present invention is in no way limited to the details of the described embodiments but changes may be made without departing from the scope of the invention. For example, although the LCD display is used as the display in the embodiment, other displays such as organic EL displays, inorganic EL displays, etc. can be used accordingly.

Additionally, a semitransparent button sheet can be used instead of the transparent button sheet. Also, a shape of the transparent button sheet may have other shapes as long as the shapes enable a user to know a position of a button displayed on an LCD panel using their sense of touch. Both a sheet having round buttons and a flat sheet having protrusions at the position corresponding to the center of each button in a button pattern can be used. Moreover, it is possible, according to a change of a button pattern displayed on an LCD panel, to change one transparent button sheet to another which has a different shape from the former.

While, in the embodiment, the buttons displayed on the LCD panel have the same square shape and are arranged in lines of 3 by 5 in order to fit the shape and arrangement of the buttons of the transparent button sheet, it is also possible to display various patterns of the arrangement. For example, it is possible to display square/round buttons arranged in lines of 4 by 4. It is also possible to display buttons which have a different shape from each other and arranged in lines. However, the buttons must be arranged to fit a shape of a transparent button sheet, or else it is possible that the function which enables a user to know positions of buttons displayed on the LCD panel using their tactile sense will not work. For example, in the case that the transparent button sheet described in the embodiment is used, it is possible to display one button at an area on the LCD panel corresponding to an area where multiple adjacent buttons of the transparent button sheet are united.

Moreover, it is possible for the multi-functional remote controller described in the embodiment to have additional functions other than as a remote controller and for the multi-functional button to additionally function as buttons for the additional functions. For example, the multi-functional remote controller can additionally function as a cordless handset of a telephone. In this case, when the function as a telephone is used, if the button pattern as shown in FIG. 4 (a) is displayed on the LCD panel 21, the buttons can be used as the buttons for the telephone. Although functions of the cursor key and the keys A-D 31 are not described in detail in the embodiment, those keys can be used effectively in the case that other functions are added as above.

It is obvious that the present invention is not limited to use for equipment which functions mainly as a remote controller and that it can be also used for cellular phones, PHSs, or cordless handsets of fixed-line telephones. It can also be used for portable telephones which function mainly as IP telephones etc. Moreover, it can also be used as an input device for PDAs.

1. A touch screen-type input device comprising:
a touch screen comprising a display panel on which multiple button patterns can be variably displayed for multiple input purposes and a touch panel for detecting information for contact position onto the display panel;
a transparent button sheet disposed on the touch screen and having a shape to enable a user to recognize a position of each button in each button pattern on the display panel using sense of touch; and
a control means for determining which button in the button pattern displayed on the display panel was pressed down according to position information from the touch panel.

2. The touch screen-type input device as defined in claim 1, further comprising:
a click sensation providing means for providing a click sensation for a user when a button on the touch screen is pressed down.

3. The touch screen-type input device as defined in claim 2, wherein the click sensation providing means is a mechanical switch disposed under the display panel and that provides a click sensation for a user by being pressed down via the display panel when the user presses down the touch screen.

4. The touch screen-type input device as defined in claim 2, wherein the control means is connected to the click sensation providing means and outputs a button signal showing which button was pressed down when the control means receives position information from the touch panel and a signal indicating that the click sensation providing means was activated.

5. The touch screen-type input device as defined in claim 1, wherein the transparent button sheet has a shape with convexities and concavities, and each of the convexities corresponds to each button displayed on the display panel, while each of the concavities corresponds to the boundary between each button.

6. A touch screen-type input device comprising:
a touch screen comprising a display panel on which multiple button patterns can be variably displayed for multiple input purposes and a touch panel for detecting information for contact position onto the display panel;
a click sensation providing means for providing a click sensation for a user when a button on the touch screen is pressed down; and
a control means for determining which button in the button pattern displayed on the display panel was pressed down according to position information from the touch panel when the control means receives position information from the touch panel and a signal indicating that the click sensation providing means was activated.

7. A multi-functional remote controller comprising:
a touch screen comprising a display panel on which multiple button patterns can be variably displayed for operating multiple home electrical appliances and a touch panel for detecting information on contact position onto the display panel;
a transparent button sheet disposed on the touch screen and having a shape to enable a user to recognize a position of each button in each button pattern on the display panel using sense of touch; and
a control means for determining which button in the button pattern displayed on the display panel was pressed down according to position information from the touch panel.

8. A portable telephone comprising:
a touch screen comprising a display panel on which multiple button patterns can be variably displayed for multiple input purposes and a touch panel for detecting information on contact position on the display panel;
a transparent button sheet disposed on the touch screen and having a shape to enable a user to recognize a position of each button in each button pattern on the display panel using sense of touch; and
a control means for determining which button in the button pattern displayed on the display panel was pressed down according to position information from the touch panel.
